(19) United States
(12) Patent Application Publication
(10) Pub. No.: US 2006/0074529 A1
(43) Pub. Date: Apr. 6, 2006

(54) Apparatus for dispensing precise volumes of fluid

(76) Inventor: James P. Garcia, Santa Clara, CA (US)

Correspondence Address: BRINKS HOFER GILSON & LIONE, P.O. BOX 10395, CHICAGO, IL, 60610, US

(21) Appl. No.: 10/954,707

(22) Filed: Sep. 30, 2004

(51) Int. Cl. G05D 11/00

(52) U.S. Cl. 700/283; 700/285

(57) ABSTRACT

A dispensing measuring system for dispensing a measure of fluid for use with a system to treat semiconductor workpieces is disclosed. The dispensing measuring system includes at least one feedline having a receiving tank having a volumetric capacity for receiving a measure of fluid. A sensor senses when the receiving tank has received the measure of fluid. A mix tank is attached to the at least one feedline for receiving the measure of fluid from the receiving tank to create a batch of fluid. A controller is electrically connected to the at least one feedline to control the flow of fluid through the at least one feedline. The controller is electrically connected to the mix tank. A connecting line is attached to the mix tank.

### FIELD OF INVENTION

The present invention relates generally to equipment for processing semiconductor workpieces. More particularly, the present invention relates to dispensing fluid for use in connection with a system to treat semiconductor workpieces.

### BACKGROUND

Chemical mechanical polishing (CMP) is used for planarizing semiconductor wafers during processing of the wafers. Because semiconductor circuits on wafers are commonly constructed in layers, where a portion of a circuit is created on a first layer and conductive vias connect it to a portion of the circuit on the next layer, each layer can add or create topography on the wafer that must be smoothed out before generating the next layer. In order to improve the manufacturability of the circuits on the wafer, many processing steps require planarizing the wafer surface. For example, to improve the uniformity of deposition of the conductive vias, the wafer is planarized prior to deposition to reduce the peaks and valleys on the surface over which the metal is deposited.

In conventional planarization technology, a rotating wafer carrier head brings the wafer into contact with a polishing pad or belt assembly moving in the plane of the wafer surface to be planarized, and pressure is applied to a semiconductor wafer in order to support the wafer face down against a moving polishing pad. In order to planarize, or polish the wafer, a slurry dispenser dispenses a slurry onto the polishing pad. Generally, the slurry includes two components. Different applications will require different components of the slurry, depending on the material to be removed or polished. In one example, abrasive particles such as silicon dioxide or alumina are combined with a chemical such as potassium hydroxide. The chemical operates to soften or hydrate the wafer surface and the abrasive particles operate to remove the surface material.

Once the wafer has been planarized, excess slurry remaining on the wafer surface should be removed. Once way to remove slurry is to subject the wafers to a chemical bath. However, so the chemical bath will not damage the wafers, the composition of the chemical bath must be accurate. Thus, the volume of each chemical required to compose the chemical bath must be precisely measured.

One way to measure the chemicals comprising the chemical bath is to dispense the chemicals through the use of a mass flow controller (MFC). An MFC is a device that is in-line with a flow path for dispensing a chemical that makes up part of the chemical path. The MFC regulates and measures the amount of fluid passing through the flow path via a feed back loop. The MFC senses and provide feedback to a valve that opens or closes to allow chemical to pass through the flow path. However, MFCs are expensive, and a separate MFC is required for each chemical making up a part of the chemical bath.

Accordingly, there is a need in the art for an improved chemical dispensing measuring system.

### BRIEF SUMMARY

In order to address the need for improved chemical dispensing measuring systems, a dispensing measuring system for dispensing a measure of fluid for use with a process associated with a chemical mechanical polishing system is provided that includes at least one feedline having a receiving tank. The receiving tank has a volumetric capacity for receiving a measure of fluid and a sensor for sensing when the receiving tank has received the measure of fluid. A mix tank is attached to the at least one feedline for receiving the measure of fluid from the receiving tank to create a batch of fluid. A controller is electrically connected to the at least one feedline to control the flow of fluid through the at least one feedline. The controller is electrically connected to the mix tank. A connecting line is attached to the mix tank.

Another aspect of the dispensing measuring system includes two feedlines, with each feedline having a receiving tank having a volumetric capacity for receiving a measure of fluid. The measure of fluid of the receiving tanks are different from each other, and a sensor associated with each receiving tank senses when the receiving tank has received the measure of fluid. A mix tank is attached to the feedlines for receiving the measure of fluid from the receiving tanks to create a batch of fluid. A controller is electrically connected to the feedlines to control the flow of fluid through the feedlines and is electrically connected to the mix tank. A connecting line is attached to the mix tank.

A method for dispensing fluid through a fluid dispensing measuring system is also included herein. The fluid dispensing measuring system includes having at least a first receiving tank having a volumetric capacity for receiving a first measure of fluid, a first sensor for sensing the first measure of fluid within the first receiving tank, a mix tank connected with the first receiving tank, a mix sensor for sensing a batch of fluid, and a source of fluid. The method includes: a) providing the first measure of fluid from the source to the first receiving tank; b) sensing with the first sensor when the first measure of fluid has been received by the first receiving tank; and c) transferring the first measure of fluid from the first receiving tank to the mix tank.

Another aspect of the method includes: a) providing a first measure of fluid from a source of fluid to a first receiving tank; b) sensing with a sensor when the first measure of fluid has been received by the first receiving tank; and c) pumping less than the first measure of fluid from the first receiving tank to a mix tank with a micro dispenser.

A computer readable medium being program code recorded thereon for calculating volumes to dispense fluid to a fluid dispensing measuring system for creating a chemical batch of fluid for use with a chemical mechanical polishing system is also included. The chemical batch of fluid has a chemical batch volume. The chemical batch includes at least a first chemical and deionized water. The chemical dispensing measuring system includes a first and a second receiving tank receiving a first measure and a second measure of fluid, respectively. The program code includes instructions for calculating a fluid volume for the first chemical. A count factor for the first chemical is calculated by dividing the fluid volume of the first chemical by the total measure of fluid of the first and the second receiving tanks. The count factor includes a whole number portion and a decimal portion. A number of double shots of the first chemical to be dispensed by the fluid dispensing measuring system is determined. The number of double-shots is equal to the whole number portion of the count factor. A micro dispenser volume to be pumped using a micro dispenser is also determined.

### BRIEF DESCRIPTION OF THE DRAWINGS

FIG. 1 is a view of a first embodiment of a chemical dispensing measuring system;

FIG. 2 is a view of a second embodiment of a chemical dispensing measuring system;

FIG. 3 is a view of a third embodiment of a chemical dispensing measuring system;

FIG. 4 is a diagram of an algorithm for dispensing fluids to a mix tank;

FIG. 5 shows a process of dispensing a double shot of fluid;

FIG. 6 shows a process of dispensing fluid from a micro dispenser;

FIG. 7 shows a process of dispensing a single shot of fluid from a first receiving tank and fluid from a micro dispenser; and

FIG. 8 shows a process of dispensing a single shot of fluid from a second receiving tank and fluid from a micro dispenser.

### DETAILED DESCRIPTION OF THE DRAWINGS AND THE PRESENTLY PREFERRED EMBODIMENTS

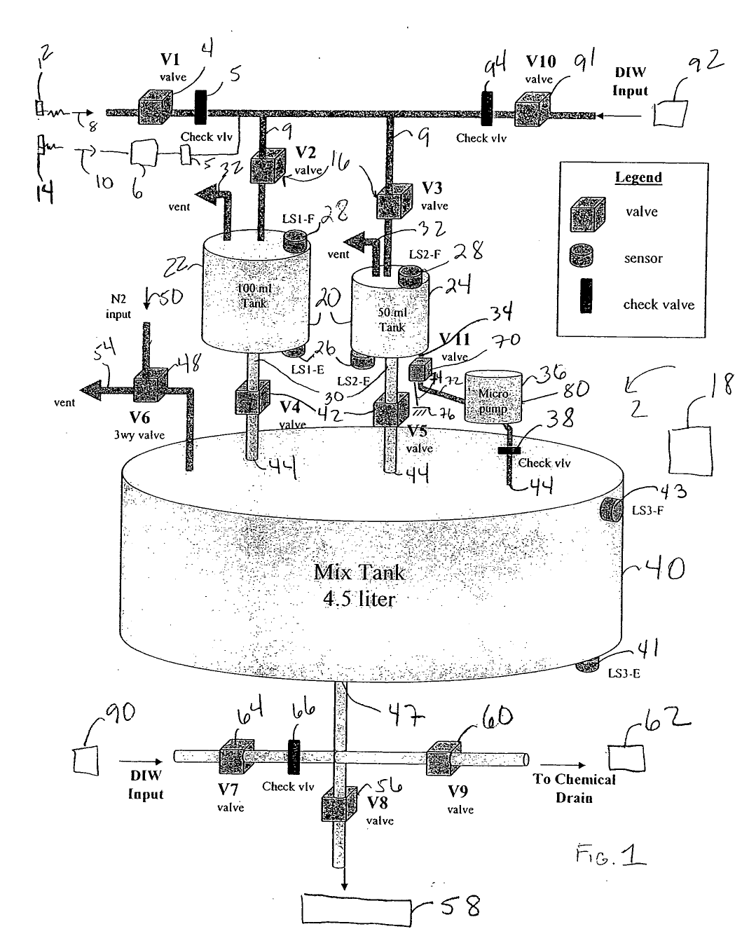

Referring now to the drawings, FIG. 1 is a perspective view of a fluid dispensing measuring system 2. The dispensing measuring system 2 typically is for use with a chemical mechanical polishing or planarization (CMP) system (not shown) for polishing a workpiece. The dispensing measuring system 2 in the illustrated embodiment is adapted the cleaning of semiconductor wafers. However, the operative principles embodied in the dispensing measuring system 2 may be applied to chemical mechanical polishing of other workpieces as well.

The dispensing measuring system includes a pair of valves 4, 6, that, when open, each allows the passage of a fluid in the direction of arrows 8, 10, respectively to a line feed 9. A check valve 5 is associated with each valve 4, 6, to prevent the backflow of fluid. Note that although there may be numerous line feeds, a preferred embodiment will include two line feeds. The fluid that passes through each valve originates from a source, 12, 14. As will be described further below, a preferred embodiment contemplates the passage of fluid from only one source at a time, although those skilled in the art will see how the system may be modified to allow the passage of two sources of fluid concurrently.

The fluids may be different from each other or may be of the same composition. The fluid may be of any type that is suitable for use with processes involving semiconductor wafers. Suitable examples include, but are not limited to, hydrofluoric acid, hydrogen-peroxide, deionized water, ammonium-hydroxide, and sulfuric acid.

The system 2 also includes a normally-closed inlet valve 16 associated with each line feed 9. Preferably, the inlet valve is a standard, chemical-resistant two-way valve, such as that available through Entegris, Inc. of Chaska, Minn. The inlet valve may be pneumatic, electromechanical, or of any type suitable for controlling the passing of fluid.

The system is controlled by a controller 18 electrically connected with the system 2. The controller 18 communicates electrical signals to and from the system 2. When a fluid passes through the system 2, the controller 18 provides electrical signals to open/close the various components associated with the feedlines 9 that are discussed below.

Upon passing through the valves, the fluid will pass through an inlet 19 into a receiving tank 20, with one receiving tank being associated with each line feed. Preferably, the receiving tanks are of different sizes, and more preferably a first receiving tank 22 has a volume of approximately 100 milliliters (ml) and a second receiving tank 24 has a volume of approximately 50 ml. However, the receiving tanks may be otherwise sized and may in fact be the same size. The receiving tanks, as well as the feedlines 9 and associated components, are preferably made of materials that will not corrode and is inert when exposed to chemicals of the type listed above. Suitable examples include but are not limited to polytetrafluoroethylene, steel, polyvinylidene fluoride or chemical-resistant plastics.

First and second sensors 26, 28 are associated with each receiving tank 20. The first sensor 26 senses when the receiving tank does not contain fluid. The second sensor 28 senses when the receiving tank contains a measure of fluid. The sensors are of a non-invasive type that do not contact the fluid but instead may sense the fluid from the exterior of the tank. Preferably, the sensors are capacitive sensors and are adjustable. Normally, the sensors 26, 28 will be adjusted so that they sense when the receiving tank is empty of fluid and contains fluid at full capacity, respectively. However, depending on the amount of fluid that is desired for the receiving tank to contain, the first and/or second sensors may be otherwise adjusted. For example, the sensor 28 may be adjusted to sense a measure of fluid that is less than the full capacity of the receiving tank 20.

The receiving tank 20 also includes an outlet 30 and a vent 32. The outlet 30 allows fluid in the tank to pass from the tank. The vent 30 associated with each receiving tank 20 allows for the displacement of air from the receiving tank when the receiving tank is filling with fluid.

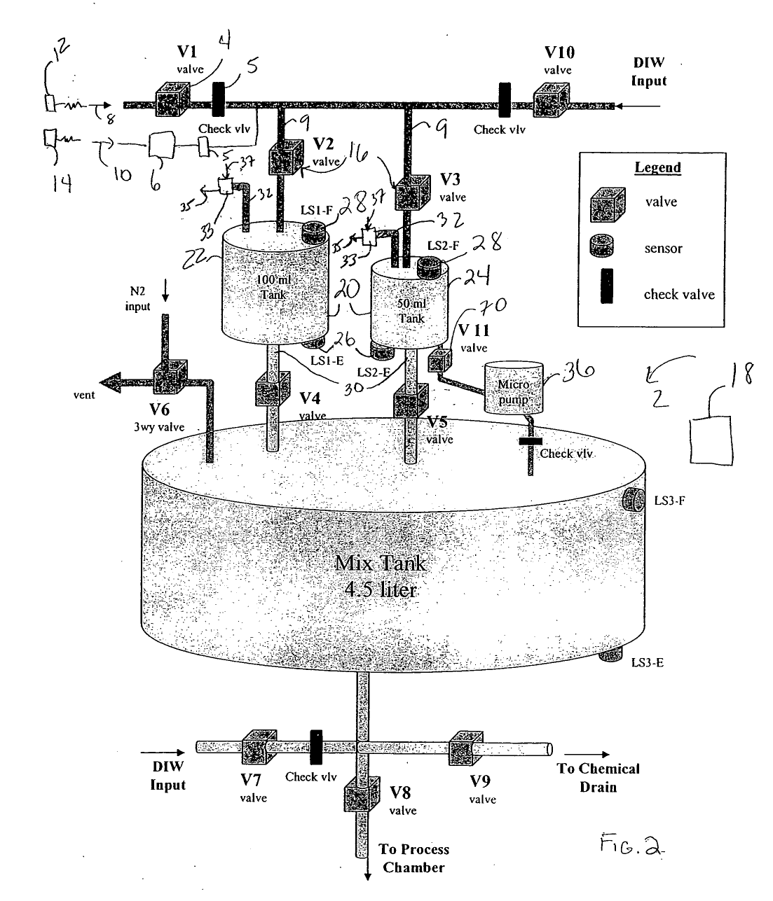

Note that the fluid passing through the feedline 9 may be either gravity-fed or pressurized in order to pass from each of the sources through feedlines 9. For gravity-fed embodiments, this means that the various components of the system 2 should be positioned so that fluid flows through the system 2 via gravity acting on the fluid, i.e., so fluid flows in a downwardly direction in accordance with a gravitational pull acting on the fluid. For embodiments using a pressurized fluid, the vent 32 may include a valve 33. FIG. 2 shows an embodiment of the system that includes valve 33, with common components being labeled the same. The valve 33 is a 3-way valve, with the arrow indicated by 35 showing the passage of air from the vent, and with the arrow indicated by 37 showing the passage of a pressurized gas such as nitrogen being introduced into the receiving tank in order to pressurize the fluid. If the fluid is pressurized, a desirable pressure often will be 6 pounds per square inch, although in other embodiments other pressure values may be used.

Preferably, at least one of the receiving tanks 20 includes a second outlet 34. The second outlet 34 allows fluid to pass from the receiving tank 20, through a dispenser valve 70 and then to a micro dispenser 36 that is connected with the receiving tank 20. The micro dispenser 36 will transfer a volume of fluid from the receiving tank 20 that is less than the measure of fluid associated with the receiving tank 20 with which the micro dispenser 36 is attached. Note that the measure of fluid may not only be based on the size of the receiving tank 20 but may also be based on the adjustment of the sensor 28 that senses when the receiving tank 20 contains fluid. For example, if the sensor 28 is adjusted to sense when fluid fills half of the receiving tank 20, the micro dispenser 36 will transfer a volume of fluid from the receiving tank 20 that is less than half the capacity of the receiving tank 20. The micro dispenser 36 may be associated with either receiving tank 22, 24. A check valve 38 is associated with the micro dispenser 36 to prevent the backflow of fluid after it passes from the micro dispenser 36.

In one embodiment, the micro dispenser 36 may be a micropump 80. The micropump 80 may be of any capacity, depending on system requirements, but typically will have a capacity of less than 50 ml (assuming that the micropump is attached to a receiving tank that receives a measure of fluid of 50 mil). Preferably the micropump is a self-priming, micro-dispensing, solenoid-actuated micropump, such as a pump available from Bio-Chem Valve Inc., Boonton, N.J., model nos. 090SP, 120SP or 150SP. Another example of a suitable pump is model no. Reglo Analog MS-2/6, a peristaltic pump available from Micropump, Inc. of Vancouver, Wash.

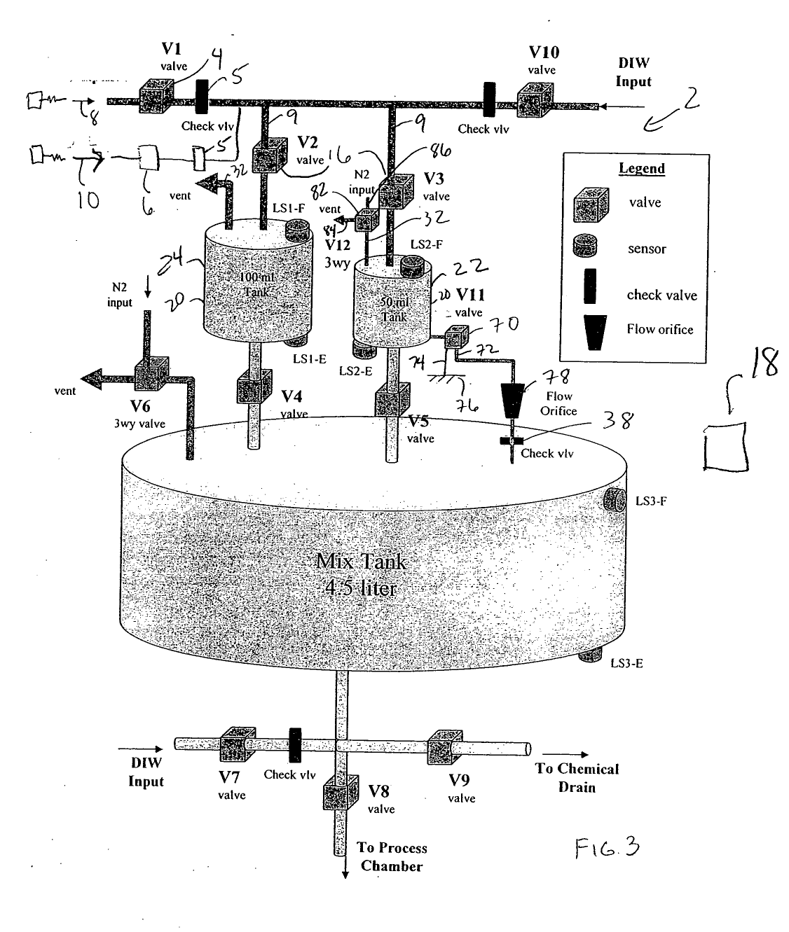

In another embodiment, the micro dispenser 36 may be a flow orifice dispenser 78. FIG. 3 shows an embodiment of a system 2 that includes a flow orifice dispenser 78, with common components being labeled the same. The flow orifice dispenser 78 passes fluid at a fixed flow rate. In order for the flow orifice dispenser 78 to operate efficiently, the inlet pressure of the fluid should be fixed. To fix the inlet pressure of fluid, a valve 82 may be attached at the vent 32 of the receiving tank 20. The valve 82 is a 3-way valve and may be the same type as the valve 33 described above. One “branch” of the valve 82, depicted as 84, allows for the displacement of air as described above. The other branch 86 allows the introduction of a pressurized gas such as nitrogen into the receiving tank 20 so that enters the flow orifice dispenser at a fixed inlet pressure.

The dispenser valve 70 is a 3-way valve. One branch of the dispenser valve 70, depicted as 72, isolates the micropump 36 from the receiving tank 22. Another branch of the valve, depicted as 74, acts as a purge leading to a drain 76 to empty the receiving tank 22 of any fluid not pumped out of the receiving tank 22 by the micropump 36 or otherwise dispensed.

A normally-closed outlet valve 42 is associated with each line feed 9. When opened, the outlet valve 42 allows fluid to exit from the receiving tank 20. The outlet valve 42 is of the same type as the inlet valve 16 described above. When the outlet valve 42 is opened, fluid from the receiving tank 20 passes into a mix tank 40.

The mix tank 40 receives fluids from the receiving tanks 20 via inlets 44, with there being a separate inlet 44 associated with each receiving tank 20 (and micro dispenser 36). The mix tank 40 provides a space for fluids from the various line feeds 9 to mix into a homogenous fluid. The mix tank 40 is of a construction similar to that of the receiving tank 20, i.e., of a material that will not corrode and is inert when exposed to chemicals such as those described above. The mix tank 40 should be of a total volumetric capacity that is at least equal to the total measure of fluid of the receiving tanks 20 and the volume of fluid that passes through the micro dispenser 36. Preferably, however, the mix tank will have a volumetric capacity of 4.5 liters. The mix tank also includes an outlet 47 that provides an egress for the mixed fluid.

The mix tank 40 also includes first and second mix sensors 41, 43. The first mix sensor 41 senses when no fluid remains in the mix tank. The second mix sensor 43 senses when a predetermined volume of a chemical batch is in the mix tank.

Preferably, the mix tank 40 includes a communication line 46 that has a mix valve 48 associated with it. The mix valve 48 is preferably a three-way valve that allows for a pressurized input, as shown by the arrow 50, in order to increase the flow rate of fluid that exits through the outlet 47 of the mix tank 40. The pressurized input may be a gas such as nitrogen. The mix valve 48 also allows air to pass from a vent, as depicted by the arrow 54, so that air may be displaced as fluid enters the mix tank 40.

Fluid is able to exit through the outlet 47 of the mix tank 40 when a normally-closed process valve 56 opens. The process valve 56 is similar to the inlet valve 16 described above. From there, fluid may flow to a process apparatus 58. The process valve is similar to the mix valve 48.

A water valve 64, also similar to the inlet valve 16, is included to allow a first source of deionized water 90 to flow to the mix tank 40 or the process apparatus 58. A check valve 66 prevents the “back-flow” of mixed fluid. Normally, after a required amount of chemicals have been dispensed to the mix tank 40, deionized water may be introduced to the mix tank until the mix tank sensor 43 senses fluid, thus making up a chemical batch.

Optionally, the dispensing measuring system 2 may include a drain valve 60, which is also similar to the inlet valve 16, to provide a drain, depicted by the arrow 62.

The process apparatus 58 is an apparatus that involves the processing of silicon wafer using techniques such as, for example, wafer cleaning, wafer etching, plating and lithography. Such an apparatus is exemplified in a chemical mechanical polishing or planarization (CMP) system for polishing a workpiece. The CMP system is adapted for planarization of semiconductor wafers. With respect to the CMP system, the dispensing measuring system may be used to supply a batch volume of slurry to a slurry dispenser. The slurry is dispensed onto a polishing pad associated with the CMP system and is used to planarize or polish a workpiece. A slurry may have a variety of compositions, with different applications requiring different components of slurry. Such a CMP system is exemplified in U.S. Pat. No. 6,761,626, filed Dec. 20, 2001, issued Jul. 13, 2004, which is herein incorporated by reference in its entirety.

An additional example of a process system is a cleaning system to clean slurry off of a workpiece that may accumulate during the planarization process. By way of example, a cleaning system may include brushes to clean both side of the workpiece. Fluid that has been mixed within the mix tank 40 and flows through the process valve 56 is injected into the brush core. The fluid is then applied to the workpiece as the brush cleans the workpiece.

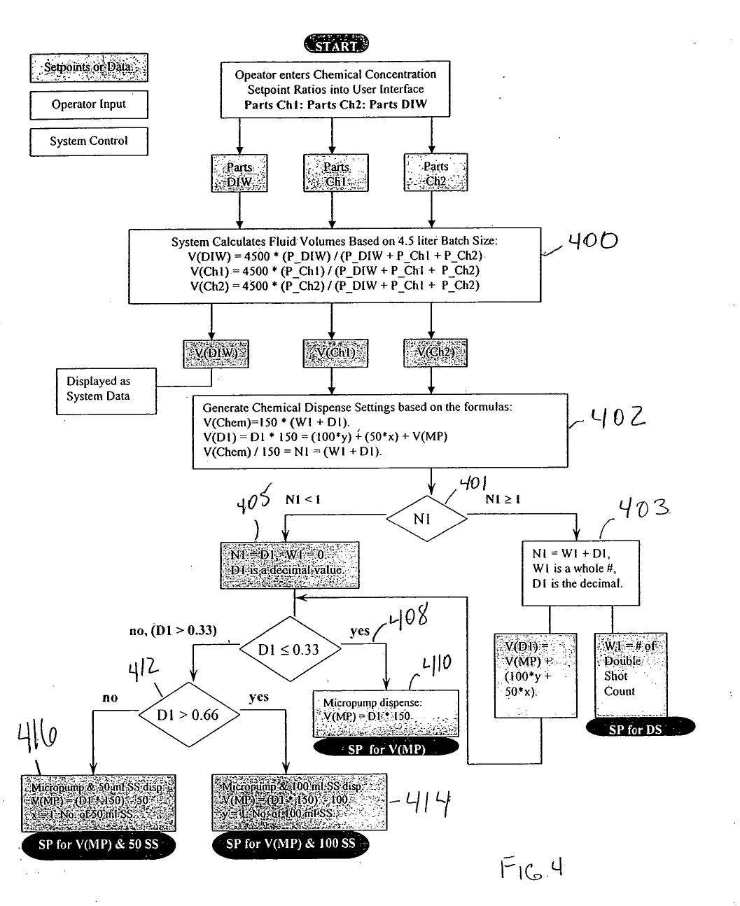

The algorithms associated with mixing and dispensing a chemical batch are now described. Referring to FIG. 4, the algorithms assume two mix tanks that receive measures of fluid equal to 100 ml and 50 ml, respectively, a desired chemical batch volume of 4500 ml and a chemical batch comprising Chemical 1, Chemical 2, and deionized water (Ch1, Ch2 and DIW, respectively). These algorithms will have been pre-programmed into a computer using program code of any suitable computer logic language. The required volumes V(Ch1), V(Ch2) and V(DIW) of Ch1, Ch2 and DIW are first calculated (at 400). The volumes are calculated by multiplying the chemical batch volume by the number of parts the chemical forms of the entire chemical batch volume divided by the total number of parts making up the entire chemical batch volume. Note that the “parts” making up the chemical batch will have been predetermined (e.g., a chemical batch made up of 3 parts Ch1, 1 part Ch2 and 15 parts DIW).

Once the required volume of each part of the chemical batch is determined, the chemical dispense settings are calculated (at 402). This requires determining: 1) the volume of each chemical to be dispensed using either the micro dispenser 36 and/or whether a single shot (SS) of chemical from either the 100 ml or 50 ml receiving tank (V(D1)) is to be dispensed; and 2) the number of times each chemical is to be dispensed using a double shot (DS) of both the 100 ml and 50 ml tanks (V(1l)). A “single shot” is when an amount of fluid from one of the receiving tanks, but not both, is dispensed. A “double shot” is when an amount of fluid is dispensed from both receiving tanks concurrently.

To calculate V(W1) and V(D1), a “count factor” N1 is first calculated. N1 is the equivalent of the total chemical volume (V(Ch1), V(Ch2) or V(DIW)) divided by the total measure of fluid of the receiving tanks (here 150 ml) (at 401). N1 is made up of a whole number portion (W1) and a decimal portion (D1). Following the logic diagram of FIG. 2, it is first determined whether N1 is greater than or equal to one. If N1 is greater than or equal to one, W1 is equal to the number of double-shot counts that make up the chemical batch (the number of times fluid is dispensed by both the 100 ml and 50 ml receiving tanks) (at 403). D1 is the number of micropump and/or single-shot dispense counts (the number of times fluid is dispensed from the micropump and/or one of the receiving tanks). Note that if D1 is equal to zero no fluid will be dispensed from the micropump and no single shots will be dispensed. Similarly, if W1 is equal to zero no double shots of fluid will be dispensed (at 405).

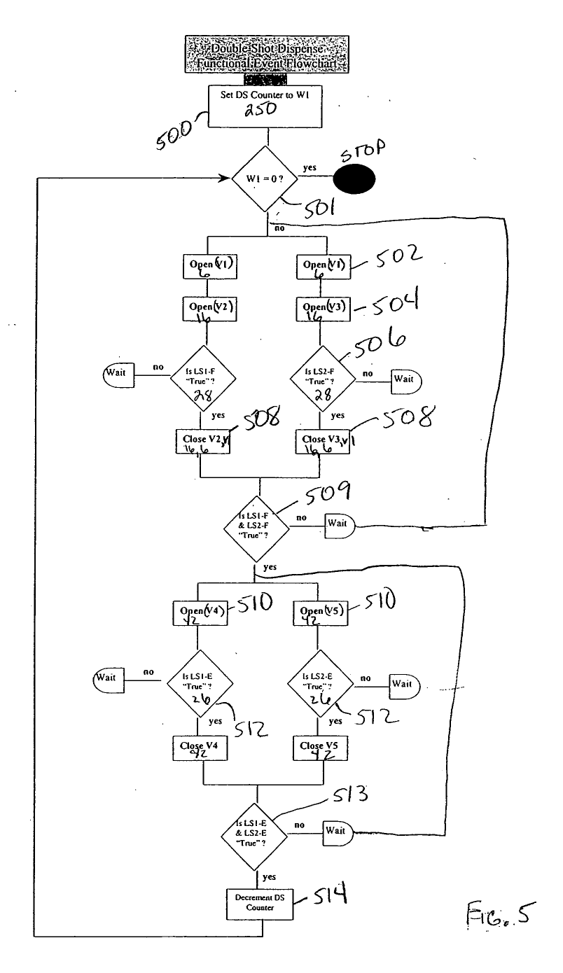

With respect to W1, FIG. 5 shows the process of concurrently dispensing fluid through both receiving tanks 22, 24 of the dispensing measuring system 2 described above, with the symbol references and component references used in FIG. 1 being referenced here. After determining that W1 is not equal to zero (at 501), fluid will pass through the valve 6 (or alternatively, valve 4, depending on the source of fluid being provided) and the inlet valves 16 associated with each feed line to pass to the receiving tanks 22, 24 (at 502, 504). Once the sensors 28 indicate that the receiving tanks contain a measure of fluid (at 506), the valves 6, 16 will close (at 508). Optionally, a “sanity check” may be provided to ensure that the sensors 28 indicate that the receiving tanks contain a measure of fluid (at 509). The outlet valves 42 associated with each feedline will then open (at 510). The outlet valves 2 will allow fluid to flow to the mix tank 40 and will remain open until the sensors 26 sense that fluid no longer remains in the receiving tanks 22, 24 (at 512). Optionally, a sanity check may be provided to ensure that the sensors sense that fluid no longer remains in the receiving tanks (at 513). A counter 250 is used to count the number of cycles for dispensing double-shots of fluid with the counter being initially set to W1 (at 500). The counter 550 is decreased each time a double shot of fluid is dispensed, with fluid ceasing to be dispensed once the counter is equal to zero (at 514). Note that in embodiments that include a flow orifice dispenser 78, the inlet fluid pressure will be fixed via the introduction of a pressurized gas through valve 82.

With respect to D1, if D1 is less than or equal to 0.33 (at 408), fluid will be dispensed from the micropump (with no single shots of fluid from a receiving tank being dispensed). The value of 0.33 is determined by dividing the smaller measure of fluid of the receiving tanks 22, 24 by the total measure of fluid of the receiving tanks combined. In this example this value is 50 divided by 150. Note that this value would change if the sensor 28 was adjusted to sense a measure of fluid within the receiving tank 24 at a value less than the total volumetric capacity (50 ml) of the receiving tank 24. The volume of fluid dispensed from the micro dispenser V(MD) is calculated to be the total measure of fluid of the receiving tanks (here 150 ml) multiplied by D1, which is the decimal portion of N1 (at 410).

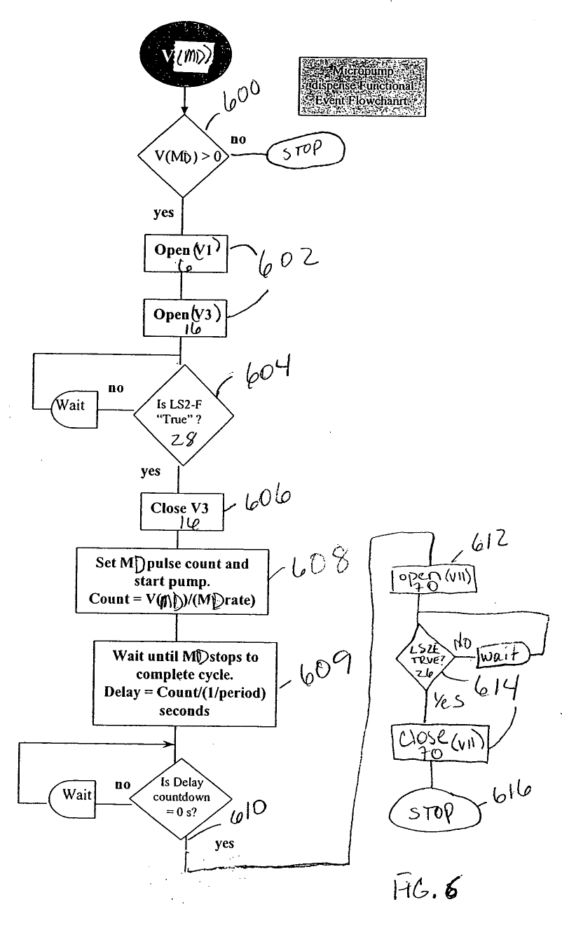

FIG. 6 shows the process of dispensing fluid through the micro dispenser 36 of the dispensing measuring system 2 described above, with the symbol references used in FIG. 2 being referenced here. After determining that V(MD) is not equal to zero (D1 is not equal to zero) (at 600), the valve 6 and the inlet valve 16 will open (at 602) and will fill the receiving tank 24 (assuming the micro dispenser 36 is connected with the receiving tank 24 and not receiving tank 22) until the sensor 28 indicates the receiving tank 24 contains a measure of fluid (at 604), at which time the valve 6 and the inlet valve 16 will close (at 606). The micro dispenser 36 will then be actuated and will start pumping fluid from the receiving tank 24 according to a pulse count (at 608). The pulse count is the number of seconds the micro dispenser 36 will pump fluid and is determined by V(MD) (calculated at 410) divided by the pump rate of the micro dispenser, which is determined by the type of micro dispenser used and the setting the micro dispenser is adjusted at. For example, if a micropump is used, the micropumps available from Bio-Chem Valve, Inc., discussed above, have pump rates in the range of 2-30 ml per minute. The pulse count decreases as the micro dispenser pumps fluid (at 609). The micro dispenser will stop pumping fluid when the pulse count reaches zero (at 610). Because no single shots are being dispensed, any fluid remaining within the receiving tank 24 will egress through the dispenser valve 70 (at 612). The valve will allow fluid remaining in the receiving tank 24 to exit to the drain 76 until the sensor 26 senses that no more fluid remains within the receiving tank 24 (at 614). When no more fluid is sensed within the receiving tank, the process stops (at 616).

If D1 is greater than 0.33, it is next determined if D1 is greater than 0.66) (at 412). The value of 0.66 is determined by dividing the larger measure of fluid of the receiving tanks 22, 24 by the total measure of fluid of the receiving tanks. In this example, this value is 100 divided by 150. Note that this value would change if the sensor 28 was adjusted to sense a measure of fluid within the receiving tank 22 at a value less than the total volumetric capacity (100 ml) of the receiving tank 22. If D1 is greater than 0.66, fluid will be dispensed from the micro dispenser 36 in an amount equal to D1 multiplied by 150 minus 100 ((D1*150)−100) (at 414). In addition, one 100 ml single shot of fluid will be dispensed.

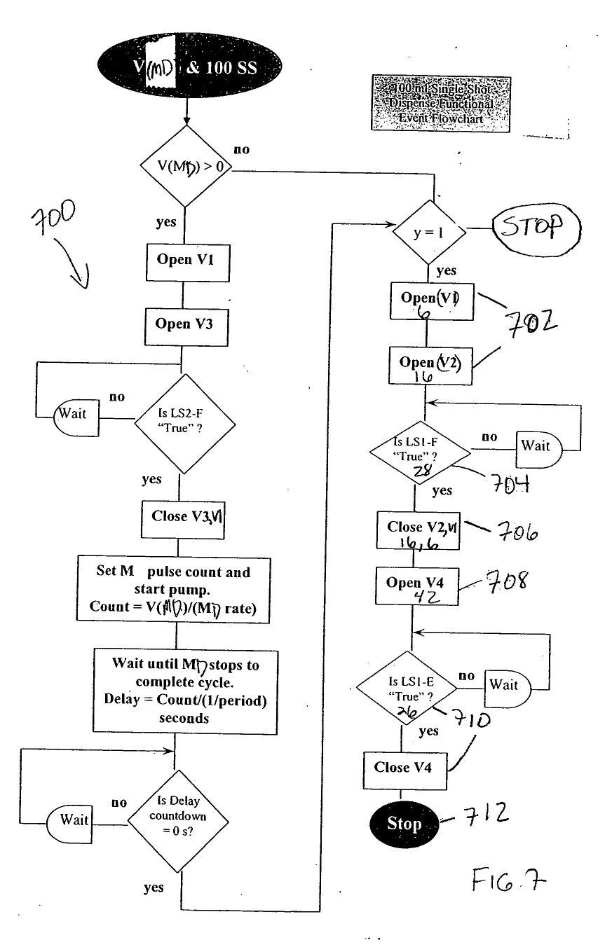

FIG. 7 shows the process of dispensing fluid through the micro dispenser 36 and the 100 ml receiving tank of the dispensing measuring system 2, with the symbol references and reference numbers used in FIG. 2 being referenced here. Dispensing fluid through the micro dispenser has already been described (at 700). Once fluid has passed through the micro dispenser, instead of fluid exiting through the dispenser valve 70, the inlet valve 16 associated with the receiving tank 22 will open to allow fluid to flow into the receiving tank 22 (at 702). The sensor 28 will sense a measure of fluid within the receiving tank (at 704), at which time the valve 6 and the inlet valve 16 will close (at 706) and the outlet valve 42 will open (at 708). The outlet valve will allow fluid to flow to the mix tank 40 and will remain open until the sensor 26 senses no fluid within the receiving tank 22 (at 710). Thus a 100 ml single shot will have been dispensed into the mix tank (at 712).

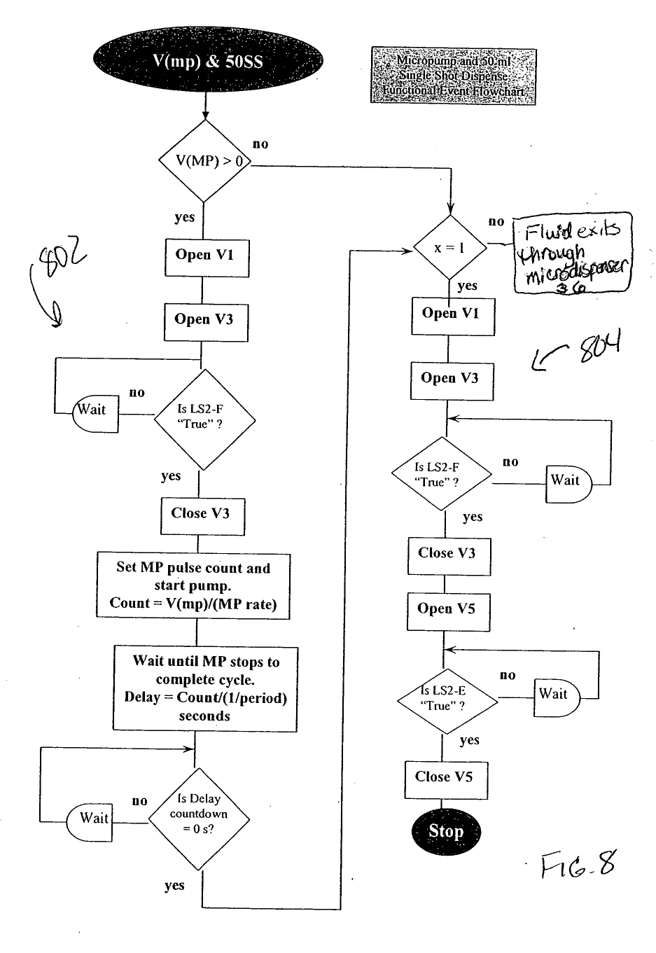

If D1 is less than or equal to 0.66, fluid will be dispensed from the micropump in an amount equal to D1 multiplied by 150 minus 50 ((D1*150)−50) (at 416). In addition, one 50 ml single shot of fluid will be dispensed. FIG. 8 shows the process of dispensing fluid through the micro dispenser 36 (at 802) and the 50 ml receiving tank (at 804) of the dispensing measuring system 2, with the symbol references and reference numbers used in FIG. 2 being referenced here. This process is the same as the process described for dispensing a single shot of 100 ml of fluid, except that the valves and sensors of the feedline 9 associated with the 50 ml receiving tank 24 will be used.

Once the chemicals are each dispensed into the mix tank 40, deionized water is added to the mix tank via the water valve 64. As noted above, water is added until the second mix sensor 43 senses fluid. However, deionized water may be added prior to the dispensing of chemicals or may be sequenced to be added before and after the dispensing of chemicals. The volume of deionized water introduced into the mix tank prior to the dispensing of chemicals could be measured based on the flow rate of the deionized water and the amount of time deionized water is allowed to flow into the mix tank. The volume of deionized water introduced into the mix tank after the dispensing of chemicals would be based on the second mix sensor 43 as described above.

The chemicals and deionized water in the mix tank are mixed into a homogenous mixture. The mixing of the fluids may be accomplished in several ways. For example, the fluids may freely combine until each fluid disperses in the solution. Mixing may also be accomplished by using the introduction of deionized water to create agitation within the mix tank, thus allowing the fluids to mix. Alternatively, mixing may be accomplished through stirring the fluids via magnetic bars or agitating rods.

As noted above, when it is desired to flush out or otherwise clean the mix tank, deionized water may be introduced into the mix tank 40 via the water valve 64, which allows the first source of deionized water 90 to be introduced. The deionized water within the mix tank may then be purged through drain valve 60 to the drain 62. Similarly, in order to flush out the receiving tanks, micro dispenser and associated valves, a second source of deionized water 92 may be introduced into the system 2. A check valve 94 associated with the second source of deionized water 92 prevents the back flow of fluid. Deionized water may then be purged through the drain 62 as described above. Note that cleaning fluids may also be introduced at the first and second sources of deionized water 90, 92 in order to clean the system. Deionized water may then be used to flush the system.

Thus, a novel apparatus for precisely dispensing fluid and a method for dispensing the fluid is disclosed. The dispensing measuring system allows fluid to be dispensed in a precise fashion, which is important so that the workpieces will not be damaged by the application of an improperly mixed chemical batch. The system also works quickly, so that workpieces may be processed quickly.

The dispensing measuring system may be modified without departing from its intended scope. For example, several dispensing measuring systems may be connected to one mix tank. Furthermore, more or less than two mix tanks may be used and more than one micropump may be incorporated if desired. It is therefore intended that the foregoing detailed description be regarded as illustrative rather than limiting, and that it be understood that it is the following claims, including all equivalents, that are intended to define the spirit and scope of this invention.

1. A dispensing measuring system for dispensing a measure of fluid for use with a system to treat semiconductor workpieces comprising:
at least one feedline having a receiving tank having a volumetric capacity for receiving a measure of fluid and a sensor for sensing when the receiving tank has received the measure of fluid;
a mix tank attached to the at least one feedline for receiving the measure of fluid from the receiving tank to create a batch of fluid; and
a controller electrically connected to the at least one feedline to control the flow of fluid through the at least one feedline and electrically connected to the mix tank; and
a connecting line attached to the mix tank.

2. The dispensing measuring system of claim 1 further comprising two feedlines, wherein each feedline includes a receiving tank.

3. The dispensing measuring system of claim 2 wherein the two receiving tanks each receives a different measure of fluid.

4. The dispensing measuring system of claim 1, 2 or 3 further comprising a micro dispenser connected to one receiving tank.

5. The dispensing measuring system of claim 4, wherein the micro dispenser is connected to the receiving tank that receives the smallest measure of fluid.

6. The dispensing measuring system of claim 4, wherein the micro dispenser is a micropump.

7. The dispensing measuring system of claim 4, wherein the micro dispenser is a flow orifice dispenser.

8. The dispensing measuring system of claim 1 wherein the at least one feedline, the receiving tank and mix tank are made from a corrosive-resistant material.

9. The dispensing measuring system of claim 1 wherein the sensor is of a non-invasive type.

10. The dispensing measuring system of claim 7 wherein the sensor is a capacitive sensor.

11. A dispensing measuring system for use with a system to treat semiconductor workpieces comprising:
two feedlines, each feedline having a receiving tank having a volumetric capacity for receiving a measure of fluid, the measure of fluid of the receiving tanks being different from each other, and a sensor associated with each receiving tank for sensing when the receiving tank has received the measure of fluid;
a mix tank attached to the feedlines for receiving the measure of fluid from each receiving tank to create a batch of fluid;
a controller electrically connected to the feedlines to control the flow of fluid through the feedlines and electrically connected to the mix tank; and
a connecting line attached to the mix tank.

12. The dispensing measuring system of claim 11 further comprising a micro dispenser connected to one receiving tank.

13. The dispensing measuring system of claim 12, wherein the micro dispenser is connected to the receiving tank that receives the smaller measure of fluid.

14. The dispensing measuring system of claim 12, wherein the micro dispenser is a micropump.

15. The dispensing measuring system of claim 12, wherein the micro dispenser is a flow orifice dispenser.

16. A method for dispensing fluid through a fluid dispensing measuring system for use with a system to treat semiconductor workpieces, the fluid dispensing measuring system having at least a first receiving tank having a volumetric capacity for receiving a first measure of fluid, a first sensor for sensing the first measure of fluid within the first receiving tank, a mix tank connected with the first receiving tank, a mix sensor for sensing a batch of fluid, and a source of fluid, comprising:
a) providing the first measure of fluid from the source to the first receiving tank;
b) sensing with the first sensor when the first measure of fluid has been received by the first receiving tank; and
c) transferring the first measure of fluid from the first receiving tank to the mix tank.

17. The method of claim 16, further comprising:
d) providing a source of deionized water to the mix tank until the mix sensor senses the batch of fluid; and
e) transferring the batch of fluid from the mix tank to a process apparatus.

18. The method of claim 16 further comprising:
d) concurrently providing a second measure of fluid from the source to a second receiving tank when the first measure of fluid is provided to the first receiving tank;
e) sensing with a second sensor when the second measure of fluid has been received by the second receiving tank; and
f) concurrently transferring the second measure of fluid from the second receiving tank to the mix tank when the first measure of fluid is transferred from the first receiving tank to the mix tank; and
g) repeating a)-f) until a set volume of the source of fluid has been transferred to the mix tank.

19. The method of claim 16, wherein providing a first measure of fluid from the first source to the first receiving tank further comprises:
pumping less than the first measure of fluid from the first receiving tank to the mix tank with a micro dispenser; and
providing the first measure of fluid from the first source to the first receiving tank.

20. A method for dispensing fluid through a fluid dispensing measuring system having at least a first receiving tank having a volumetric capacity, a sensor electrically connected to the receiving tank, a micropump connected to the first receiving tank, a mix tank connected with the first receiving tank and the micropump, a mix sensor, and a source of fluid and deionized water, comprising:
a) providing a first measure of fluid from the source to the first receiving tank;
b) sensing with the sensor when the first measure of fluid has been received by the first receiving tank; and
c) pumping less than the first measure of fluid from the first receiving tank to the mix tank with a micro dispenser.

21. The method of claim 20, further comprising:
d) providing the first measure of fluid to the first receiving tank;
e) sensing with the sensor when the first measure of fluid has been received by the first receiving tank; and
f) transferring the first measure of fluid from the first receiving tank to the mix tank.

22. The method of claim 20 further comprising:
d) purging fluid in the first receiving tank into a drain.

23. A computer readable medium being program code recorded thereon for calculating volumes to dispense fluid to a fluid dispensing measuring system for creating a chemical batch of fluid having a chemical batch volume, the chemical batch including at least a first chemical and deionized water, the chemical dispensing measuring system including a first and a second receiving tank receiving a first measure and a second measure of fluid, respectively, the program code comprising instructions for:
calculating a fluid volume for the first chemical;
calculating a count factor for the first chemical by dividing the fluid volume of the first chemical by the total measure of fluid of the first and the second receiving tanks, the count factor including a whole number portion and a decimal portion; and
determining a number of double shots of the first chemical to be dispensed by the fluid dispensing measuring system, wherein the number of double-shots is equal to the whole number portion of the count factor; and
determining a micro dispenser volume to be pumped using a micro dispenser.

24. The program code of claim 23, the instructions further comprising:
determining a single shot of fluid equal to the first measure of fluid is to be dispensed.

25. The program code of claim 23, the instructions further comprising:
determining a single shot of fluid equal to the second measure of fluid is to be dispensed.

26. The program code of claim 23 wherein the instructions for determining a micro dispenser volume to be pumped using the micro dispenser further comprise:
calculating a duration of time the micro dispenser pumps fluid by dividing the micro dispenser volume by a pump rate associated with the micro dispenser.
